(19) United States
(12) Patent Application Publication
(10) Pub. No.: US 2023/0287018 A1
(43) Pub. Date: Sep. 14, 2023

(54) PROCESS FOR PREPARING SILOXANES

(71) Applicant: WACKER CHEMIE AG, Munich (DE)

(72) Inventor: Elke FRITZ-LANGHALS, Ottobrunn (DE)

(73) Assignee: Wacker Chemie AG, Munich (DE)

(21) Appl. No.: 18/020,448

(22) PCT Filed: Aug. 21, 2020
(86) PCT No.: PCT/EP2020/073525

§ 371 Date: Feb. 9, 2023

(51) Int. Cl. C07F 7/08; C07F 7/18; C07F 17/00

(52) U.S. Cl. CPC C07F 7/0874; C07F 7/1872; C07F 17/00

(57) ABSTRACT

A process for preparing siloxanes, wherein at least one alkoxy-organosilicon compound selected from compounds of the general formula (I) and/or from compounds of the general formula (II) is/are reacted in the presence of a cationic silicon and/or germanium compound at a temperature of −40 to 250° C.

The invention relates to a process for preparing siloxanes from alkoxy-organosilicon compounds of the general formula (I) and/or (II) in the presence of at least one cationic silicon and/or germanium compound.

Siloxanes are an industrially important compound class that is used in numerous fields of technology. The preparation of siloxanes is therefore an important process in industrial organosilicon chemistry. By way of example, one process that has become established on an industrial scale is the hydrolytic condensation starting from chlorosilanes according to the following reaction equation:

2R₃Si—Cl+H₂O=>R₃Si—O—SiR₃+2HCl

Another process that has become established is the hydrolytic condensation of alkoxy group-containing silanes and siloxanes, which are each raw materials produced on an industrial scale:

R₃Si—OR+H₂O=>R₃Si—OH+ROH;

2R₃Si—OH=>R₃Si—O—SiR₃+H₂O

However, these hydrolytic condensations always have to be carried out with an excess of water, since silanols formed in the first step then react further to form siloxanes with reformation of water. The condensation of alkoxy group-containing organosilicon compounds also requires hydrochloric acid as catalyst which, together with the water and the alcohol formed, has to be completely removed again after the reaction. This constitutes a disadvantage which makes the hydrolytic condensation process more difficult, particularly in the case of crosslinking reactions. A disadvantage of the hydrolytic condensation of methoxysil(ox)anes is the formation of methanol, which is generally likely to be undesirable because of its toxicity.

Shimada and Jorapur, in Synlett 2010, 23, 1633, describe the synthesis of symmetrical disiloxanes from the alkoxysilanes in the presence of molar amounts of Meerwein's salt (Me₃OBF₄, Et₃OBF₄ or Et₃OPF₆) in acetonitrile and with addition of potassium carbonate. The large amounts of Meerwein's salt that are required make the process uneconomic. During the work-up, large amounts of salts also have to be separated off in a technically complex manner. The process is therefore not suitable for crosslinking processes.

Gautret et al., in Synth. Commun. 1996, 26, 707, describe the transformation of trimethylsilylated diarylcarbinol to hexamethyldisiloxane and bis(diarylmethyl) ether at room temperature in the presence of 1% trifluoroacetic acid as catalyst. This process is also not suitable in principle for crosslinking processes involving formation of Si—O—Si bonds, since these bonds are not stable with respect to strong acids such as trifluoroacetic acid.

The object of the invention was that of providing a process for siloxane preparation which can be used on an industrial scale and in which alkoxy group-containing organosilicon compounds can be linked to form siloxanes without a hydrolysis step.

This object is achieved by a process in which at least one alkoxy-organosilicon compound which is selected from compounds of the general formula (I)

R¹R²R³Si—OR^{x} (I),
where R¹, R² and R³ are independently selected from the group comprising hydrogen, halogen, unsubstituted or substituted C₁-C₂₀ hydrocarbon radical and unsubstituted or substituted C₁-C₂₀ hydrocarbonoxy radical,
where two of the radicals R¹, R² and R³ may together form a monocyclic or polycyclic, unsubstituted or substituted C₂-C₂₀ hydrocarbon radical, where substituted in each case means that the hydrocarbon radical or hydrocarbonoxy radical independently has at least one of the following replacements:
replacement of a hydrogen atom by halogen,
—CH(═O), —C≡N, —OR^{z}, —SR^{z}, —NR^{z}₂, and —PR^{z}₂,
replacement of a CH₂ group by —O—, —S— or —NR^{z}—,
replacement of a CH₂ group not bonded directly to Si by —C(═O)—,
replacement of a CH₃ group by —CH(═O) and
replacement of a C atom by an Si atom,
where R^{z} is in each case independently selected from the group comprising C₁-C₆ alkyl radical and C₆-C₁₄ aryl radical and
where R^{x} is a C₁-C₂₀ hydrocarbon radical;
and/or an alkoxy-organosilicon compound which is selected from compounds of the general formula (II)

(SiO_{4/2})ₐ(R^{y}SiO_{3/2})_{b}[(R^{x}O)SiO_{3/2}]_{b′}(R^{y}₂SiO_{2/2})_{c}[(R^{x}O)R^{y}SiO_{2/2}]_{c′}[(R^{x}O)₂SiO_{2/2}]_{c″}(R^{y}₃SiO_{1/2})_{d}[(R^{x}O)R^{y}₂SiO_{1/2}]_{d′}[(R^{x}O)²R^{y}SiO_{1/2}]_{d″}[(R^{x}O)₃SiO_{1/2}]_{d′″} (II),
where R^{x} is as defined above and R^{y} is as defined for R¹, R² or R³ and
where the indices a, b, b′, c, c′, c″, d, d′, d″, d′″ each indicate the number of the respective siloxane unit and independently represent an integer from 0 to 100 000, with the proviso that the sum total of all indices has a value of at least 2 and at least one of the indices b′, c′, c″, d′, d″ or d′″ is not equal to 0,
is reacted in the presence of at least one cationic silicon and/or germanium compound at a temperature of −40° C. to 250° C., preferably 0° C. to 200° C., particularly preferably 10° C. to 100° C.

Preferably, none of the radicals R¹, R² and R³ are hydrogen.

Preferably, the radicals R¹, R² and R³ are independently selected from the group comprising hydrogen, unsubstituted or substituted C₁-C₁₂ hydrocarbon radical and unsubstituted or substituted C₁-C₁₂ hydrocarbonoxy radical.

Particularly preferably, the radicals R¹, R² and R³ are independently selected from the group comprising methyl, ethyl, vinyl, phenyl, methoxy and ethoxy.

In formulae (I) and (II), the radical R^{x} is preferably independently selected from the group comprising unsubstituted or substituted C₁-C₁₂ hydrocarbon radical, in particular unsubstituted or substituted C₁-C₆ hydrocarbon radical.

In formulae (I) and (II), R^{x} is particularly preferably independently selected from the group comprising C₁-C₆ alkyl radical, vinyl and phenyl.

The indices a, b, b′, c, c′, c″, d, d′, d″, d′″ are preferably independently selected from an integer in the range of 0 to 1000, particularly preferably in the range of 0 to 100.

It has been found that the reaction of the alkoxy-organosilicon compounds of formulae (1) and (II) to form the corresponding siloxanes can be accelerated by the presence of carbonyl compounds and the conversion of matter can also be increased. Accordingly, it may be preferable for the reaction to be performed in the presence of at least one carbonyl compound.

The carbonyl compound is preferably selected from compounds of the general formula (III)

R^{d}—(X)ₙ—CO—(X)ₙ—R^{d} (III),
where R^{d} is independently hydrogen or an unsubstituted or substituted C₁-C₄₀ hydrocarbon radical, where the two radicals R^{d} may also be joined to one another and thus form a ring (preferably a 4- to 7-membered ring). X here is independently oxygen, —N(H)— or —N(R^{d})—, where independently n=0 or 1.

As examples of the carbonyl compound (III), mention may be made of:
aldehydes such as formaldehyde, acetaldehyde, propionaldehyde and benzaldehyde
ketones such as acetone, methyl ethyl ketone, methyl isobutyl ketone, diethyl ketone, cyclopentanone, cyclohexanone, cycloheptanone, acetophenone and pinacolone
carboxylic esters such as methyl acetate, ethyl acetate and methyl propionate
lactones such as caprolactone, butyrolactone and valerolactone
carbonates such as dimethyl carbonate, diethyl carbonate and ethylene carbonate,
urethanes such as dimethyl carbamate and diethyl carbamate
ureas such as urea, N,N′-dimethylurea, N,N′-diethylurea and tetramethylurea

Particularly preferably, n=0 and R^{d} is independently hydrogen or a C₁-C₁₂ hydrocarbon radical, preferably a C₁-C₆ alkyl radical, particularly preferably a C₁-C₄ alkyl radical. In particular, the carbonyl compound is selected from the group comprising acetaldehyde, formaldehyde, acetone and methyl ethyl ketone.

Instead of the aldehydes, use may also be made of the corresponding acetals or ketals since they are in equilibrium with the aldehydes in the presence of the cationic silicon and/or germanium compounds. For example, paraldehyde or acetaldehyde diethyl acetal may be used instead of acetaldehyde, and 1,3,5-trioxane may be used instead of formaldehyde.

The carbonyl compound may be used in a proportion by weight of 0.01% to 500%, preferably 0.1% to 100%, particularly preferably 1% to 50%, based on the weight of the compound of the general formula (I) or (II) or, if mixtures of (I) and (II) are used, based on the total weight of the compounds of the general formula (I) and (II).

The cationic silicon and/or germanium compound used as catalyst is preferably selected from compounds of the general formula (IV)

([M(II)Cp]⁺)ₐX^{a-} (IV),
where X^{a-} is an a-valent anion, where a=1, 2 or 3;
where M is germanium(II) or silicon(II) and
where Cp is a π-bonded cyclopentadienyl radical of the general formula (IVa)

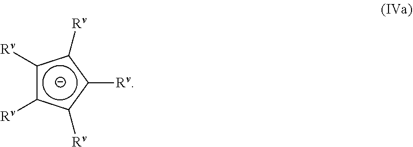

R^{v} here is independently selected from the group comprising hydrogen, unsubstituted or substituted C₁-C₂₀ hydrocarbon radical, unsubstituted or substituted C₁-C₂₀ hydrocarbonoxy radical and triorganosilyl radical of the formula —SiR^{b}₃, where R^{b} is independently selected from the group of C₁-C₂₀ hydrocarbon radical and C₁-C₂₀ hydrocarbonoxy radical, where two radicals R^{v} may in each case also be joined to one another so that bi- or polycyclic rings are formed, for example indenyl or fluorenyl rings.

As an alternative or in addition, the cationic silicon and/or germanium compound may be selected from compounds of the general formula (V)

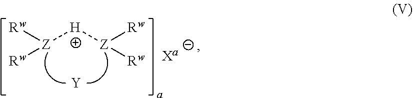

where X^{a-} is an a-valent anion, where a=1, 2 or 3;
where Z is independently silicon(IV) or germanium(IV);
where Y is a divalent C₂-C₅₀ hydrocarbon radical and
where R^{w} is independently hydrogen or a C₁-C₅₀ hydrocarbon radical.

In formulae (IV) and (V), X^{a-} is preferably monovalent anions where a=1.

As examples of monovalent anions X⁻, mention may be made of:
halides;
chlorate ClO₄⁻;
tetrachlorometalates [MCl₄]⁻, where M=Al, Ga;
tetrafluoroborates [BF₄]⁻;
trichlorometalates [MCl₃]⁻, where M=Sn, Ge;
hexafluorometalates [MF₆]⁻, where M=As, Sb, Ir, Pt;
perfluoroantimonates [Sb₂F₁₁]⁻, [Sb₃F₁₆]⁻, and [Sb₄F₂₁]⁻;
triflate (=trifluoromethanesulfonate) [OSO₂CF₃]⁻;
tetrakis(trifluoromethyl)borate [B(CF₃)₄]⁻; tetrakis(pentafluorophenyl)metalates [M(C₆F₅)₄]⁻, where M=Al, Ga;
tetrakis(pentachlorophenyl)borate [B(C₆Cl₅)₄]⁻;
tetrakis[(2,4,6-trifluoromethyl(phenyl)]borate {B[C₆H₂(CF₃)₃]}⁻;
hydroxybis[tris(pentafluorophenyl)borate] {HO[B(C₆F₅)₃]₂}⁻;
closo-carborates [CHB₁₁H₅Cl₆]⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂]⁻ and B₁₂Cl₁₁N(CH₃)₃]⁻;
tetra(perfluoroalkoxy)aluminates [Al(OR^{PF})₄]⁻, where R^{PF}=independently perfluorinated C₁-C₁₄ hydrocarbon radical;
tris(perfluoroalkoxy)fluoroaluminates [FAl(OR^{PF})₃]⁻, where R^{PF}=independently perfluorinated C₁-C₁₄ hydrocarbon radical;
hexakis(oxypentafluorotellurium)antimonate [Sb(OTeF₅)₆]⁻;
borates and aluminates of the formulae [B(R^{a})₄]⁻ and [Al(R^{a})₄]⁻, where the radicals R^{a} are in each case independently selected from aromatic C₆-C₁₄ hydrocarbon radical in which at least one hydrogen atom has been independently substituted by a radical selected from the group comprising fluorine, perfluorinated C₁-C₆ alkyl radical and triorganosilyl radical of the formula —SiR^{b}₃, where R^{b} is independently a C₁-C₂₀ alkyl radical.

Particularly preferably, X⁻ (a=1) is independently selected from the group comprising [B(SiCl₃)₄]⁻, compounds of the formula [B(R^{a})₄]⁻ and compounds of the formula [Al(OR^{c})₄]⁻, where R^{c} is independently a fluorinated, aliphatic C₃-C₁₂ hydrocarbon radical.

In particular, in formula (IV) the anions X⁻ are selected from the group comprising compounds of the formulae [B(SiCl₃)₄]⁻ and [B(R^{a})₄]⁻, wherein the radicals R^{a} are independently selected from aromatic C₆-C₁₄ hydrocarbon radical in which all hydrogen atoms have been independently substituted by a radical selected from the group comprising fluorine and triorganosilyl radical of the formula —SiR^{b}₃, wherein the radicals R^{b} independently represent C₁-C₂₀ alkyl radical.

Very particularly preferably, in formula (IV) the anions X⁻ are selected from the group consisting of the compounds of the formulae [B(SiCl₃)₄]⁻ and [B(R^{a})₄]⁻, wherein the radicals R^{a} are independently selected from the group consisting of —C₆F₅, perfluorinated 1- and 2-naphthyl radical, —C₆F₃(SiR^{b}₃)₂ and —C₆F₄(SiR^{b}₃), wherein the radicals R^{b} each independently represent C₁-C₂₀ alkyl radical.

As examples of radicals R^{a}, mention may be made of: m-difluorophenyl radical, 2,2,4,4-tetrafluorophenyl radical, perfluorinated 1-naphthyl radical, perfluorinated 2-naphthyl radical, perfluorobiphenyl radical, —C₆F₅, —C₆H₃(m-CF₃)₂, —C₆H₄(p-CF₃), —C₆H₂(2,4,6-CF₃)₃, —C₆F₃(m-SiMe₃)₂, —C₆F₄(p-SiMe₃), —C₆F₄(p-SiMe₂t-butyl).

As examples of radicals R^{V} in formula (IVa), mention may be made of:
alkyl radicals such as methyl, ethyl, n-propyl, isopropyl, n-butyl, sec-butyl, isobutyl, tert-butyl, n-pentyl, sec-pentyl, isopentyl, neopentyl and tert-pentyl radical; hexyl radicals such as n-hexyl radical; heptyl radicals such as n-heptyl radical; octyl radicals such as n-octyl radical and isooctyl radicals (for example 2,4,4-trimethylpentyl radical); nonyl radicals such as n-nonyl radical; decyl radicals such as n-decyl radical; dodecyl radicals such as n-dodecyl radical; hexadecyl radicals such as n-hexadecyl radical; octadecyl radicals such as n-octadecyl radical; cycloalkyl radicals such as cyclopentyl, cyclohexyl and cycloheptyl radical and methylcyclohexyl radical; aryl radicals such as phenyl, naphthyl, anthracene and phenanthrene radical; alkaryl radicals such as o-, m- and p-tolyl, xylyl, mesitylenyl and o-, m- and p-ethylphenyl radical; alkaryl radicals such as benzyl radical, α- and β-phenylethyl radical; and alkylsilyl radicals such as trimethylsilyl, triethylsilyl, tripropylsilyl, dimethylethylsilyl, dimethyl-tert-butylsilyl and diethylmethylsilyl radical.

In formula (IVa), the radicals R^{v} are preferably independently selected from the group comprising C₁-C₃ alkyl radical, hydrogen and triorganosilyl radical of the formula —SiR^{b}₃, wherein the radicals R^{b} independently represent C₁-C₂₀ alkyl radical.

Particularly preferably, the radicals R^{v} are independently selected from methyl radical, hydrogen and trimethylsilyl radical.

In particular, the cyclopentadienyl radical from formula (IV) may be pentamethylcyclopentadienyl, tris(trimethylsilyl)cyclopentadienyl and bis(trimethylsilyl)cyclopentadienyl.

According to one embodiment, the cationic silicon and/or germanium compounds are selected from the group comprising silicon(II) and germanium(II) compounds of formula (IV), where R^{v} is independently selected from the group comprising methyl radical, hydrogen and trimethylsilyl radical, and
where X^{a-}, where a=1, is selected from the group comprising [B(SiCl₃)₄]⁻, [R(C₆F₅)₄]⁻, {B[C₆F₄(4-TBS)]₄}⁻, where TBS=SiMe₂tert-butyl, and [B(2-Naph^{F})₄]⁻, where 2-Naph^{F}=perfluorinated 2-naphthyl radical.

In general, Si(II) compounds are less preferred since they are generally more difficult to obtain.

Alternatively or additionally, the cationic silicon and/or germanium compounds may be selected from the group of the cationic silicon(IV) and germanium(IV) compounds of the general formula (V), where R^{w} is independently selected from the group comprising C₁-C₆ alkyl radical and phenyl radical;
where Y is preferably a 1,8-naphthalenediyl radical, and
where X⁻ is preferably selected from the group comprising [B(C₆F₅)₄]⁻ and [B(SiCl₃)₄]⁻.

The reactants of formulae (I) and/or (II), the catalyst (formulae IV and V) and any carbonyl compound (formula III) may be brought into contact with one another in any desired sequence. Preferably, “bring into contact” means that the reactants and the catalyst are mixed, with the mixing being performed in a manner known to those skilled in the art.

The reaction according to the invention may be carried out without solvent or with addition of one or more solvents. The proportion of the solvent or solvent mixture, based on the total amount by weight of the compounds of formula (I) and (II), is preferably at least 0.01% by weight and not more than 1000 times the amount by weight, particularly preferably at least 0.1% by weight and not more than 100 times the amount by weight, very particularly preferably at least 1% by weight and not more than 10 times the amount by weight.

Solvents used may preferably be aprotic solvents, for example hydrocarbons such as pentane, hexane, heptane, cyclohexane or toluene, chlorohydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as acetonitrile or propionitrile. Preference is given to solvents or solvent mixtures having a boiling point or boiling range of up to 120° C. at 0.1 MPa. The solvents are preferably chlorinated and non-chlorinated aromatic or aliphatic hydrocarbons.

If a solvent or a carbonyl compound of the general formula (III) is used, then in a preferred embodiment the catalyst of the general formula (IV) and/or (V) is dissolved in the solvent or in the carbonyl compound and then mixed with the compound of the general formula (I) and/or (II).

The pressure during the reaction may be freely selected by those skilled in the art; the reaction may be carried out under ambient pressure or under reduced or elevated pressure. The pressure is preferably in a range of 0.01 bar to 100 bar, particularly preferably in a range of 0.1 bar to bar; very particularly preferably, the reaction is carried out at ambient pressure.

### EXAMPLES

### Example 1

201 mg of trimethylethoxysilane (formula (I) where R¹═R²═R³=Me, R^{x}=Et) was dissolved in 405 mg of dichloromethane, admixed with 8.9 mg of catalyst of formula (V) where Z=Si, Y=1,8-naphthalenediyl, R^{w}=Ph and Me, where Ph:Me=1:1, and X=B(C₆F₅)₄ and heated to 70° C. for 18 h. This formed 90 mol % each of hexamethyldisiloxane and diethyl ether based on trimethylethoxysilane used.

### Example 2

200 mg of dimethyldiethoxysilane (formula (I) where R¹═R²=Me, R³═OEt, R^{x}=Et) was dissolved in 412 mg of dichloromethane, admixed with 7.1 mg of catalyst of formula (V) where Z=Si, Y=1,8-naphthalenediyl, R^{w}=Ph and Me, where Ph:Me=1:1, and X═B(C₆F₅)₄ and heated to 70° C. for 18 h. This formed the oligomers EtO—(SiMe₂-O)ₙ—SiMe₂-OEt, where n=1 to 10, and diethyl ether. The conversion was 85%.

### Example 3

205 mg of methyltriethoxysilane (formula (I) where R¹=Me, R²═R³=OEt, R^{x}=Et) was dissolved in 417 mg of dichloromethane, admixed with 5.2 mg of catalyst of formula (V) where Z═Si, Y=1,8-naphthalenediyl, R^{w}=Ph and Me, where Ph:Me=1:1, and X═B(C₆F₅)₄ and heated to 70° C. for 24 h. This formed oligomeric siloxanes and diethyl ether. The conversion was 85%.

### Example 4

The experiment according to Example 1 was repeated using 8.0 mg of the catalyst of formula (V) where Z═Si, Y=1,8-naphthalenediyl, R^{w}=Me, and X═B(C₆F₅)₄. The reaction time at 70° C. was 2 days. This formed 95% each of hexamethyldisiloxane and diethyl ether.

### Example 5

The experiment according to Example 2 was repeated using 6.2 mg of the catalyst of formula (V) where Z═Si, Y=1,8-naphthalenediyl, R^{w}=Me and X═B(C₆F₅)₄. The reaction time at 70° C. was 2 days. This formed the oligomers EtO—(SiMe₂-O)ₙ—SiMe₂-OEt, where n=1 to 10, and diethyl ether. The conversion was 70%.

### Example 6

The experiment according to Example 3 was repeated using 5.2 mg of the catalyst of formula (V) where Z═Si, Y=1,8-naphthalenediyl, R^{w}=Me and X═B(C₆F₅)₄. The reaction time at 70° C. was 2 days. This formed oligomeric siloxanes and diethyl ether. The conversion was 45%.

### Example 7

154 mg of methyltrimethoxysilane (formula (I) where R¹=Me, R²═R³═OMe, R^{x}=Me) was admixed with 1.0 mg of Cp*Ge⁺B(C₆F₅)₄⁻ (formula (IV)) in 100 mg of dichloromethane and left to stand for 24 h. After this time, 1% of 1,1,3,3-tetramethoxydimethyldisiloxane had formed. 4 mg of methyl ethyl ketone (formula (III)) was then added, and the solution was again left to stand for 24 h. After this time, 14% of 1,1,3,3-tetramethoxydimethyldisiloxane and 2% of pentamethoxy-1,3,5-trimethyltrisiloxane had formed.

### Example 8

134 mg of dimethoxydimethylsilane (formula (I) where R¹═R²=Me, R³═OMe, R^{x}=Me) was admixed with 1.0 mg of Cp*Ge⁺B(C₆F₅)₄⁻ (formula (IV)) in 100 mg of dichloromethane and left to stand for 24 h. After this time, 2.5% of 1,3-dimethoxytetramethyldisiloxane had formed. 5 mg of methyl ethyl ketone (formula (III)) was then added and the solution was again left to stand for 24 h. After this time, 16% of 1,5-dimethoxytetramethyldisiloxane and 5% of 1,7-dimethoxyhexamethyltrisiloxane had formed.

### Example 9

136 mg of trimethylethoxysilane (formula (I) where R¹═R²═R³=Me, R^{x}=Et) was admixed with 1.1 mg of Cp*Ge⁺B(C₆F₅)₄⁻ (formula (IV)) in 100 mg of dichloromethane and left to stand for 24 h. After this time, 2.5% of 1,3-dimethoxytetramethyldisiloxane had formed. 5.5 mg of methyl ethyl ketone was then added, and the solution was again left to stand for 24 h. After this time, 11% of hexamethyldisiloxane had formed.

### Example 10: Crosslinking of MSE 100 with Cp*Ge⁺B(C₆F₅)₄⁻ and Acetaldehyde (Evidence of Dimethyl Ether Formation)

341 mg of MSE 100 is mixed with a solution of 0.18 mg of Cp*Ge⁺B(C₆F₅)₄⁻ (0.053% by weight based on MSE 100) in 70 μl of dichloromethane in an NMR tube with shaking. The sample is cooled to 2° C. and 21 mg of acetaldehyde (formula (III)), which has also been cooled to 2° C., is added. The NMR tube is sealed and left to stand for 3 h at 23° C. Dilution is performed with CD₂Cl₂ and the sample is analyzed by NMR spectroscopy. The signal at δ□□□3.2 ppm indicates the formation of dimethyl ether. MSE 100 is a siloxane that is formed from MeSi(OMe)₃ by hydrolytic condensation and comprises 31% by weight of methoxy groups.

### Example 11: Crosslinking of MSE 100 with Cp*Ge⁺B(C₆F₅)₄⁻ and Acetaldehyde

231 mg of acetaldehyde (formula (III)) and 2506 mg of MSE 100 are mixed in a SpeedMixer. 1.3 mg of Cp*Ge⁺B(C₆F₅)₄⁻ (0.052% by weight based on MSE 100) dissolved in 200 μl of dichloromethane is added to this mixture and the latter is mixed for approx. 2 min in the SpeedMixer, with the mixture having cured completely.

### Example 12: Crosslinking of MSE 100 with Cp*Ge⁺B(C₆F₅)₄⁻

The experiment according to Example 10 is repeated without the addition of acetaldehyde. The sample is still liquid after the mixing and has cured after 24 h at 23° C.

### Example 13: Crosslinking of MSE 100 with Cp(SiMe₃)₃Ge⁺B(SiCl₃)₄⁻ and Acetone

2520 mg of MSE 100 and 127 mg of acetone (formula (III), 5% by weight based on MSE 100) are mixed in a SpeedMixer. 1.2 mg of Cp(SiMe₃)₃Ge⁺B(SiCl₃)₄⁻ (formula (IV), 0.048% by weight based on MSE 100) dissolved in 180 μl of dichloromethane is added to this mixture and the latter is mixed again for approx. 2 min in the SpeedMixer. After 5 h at 23° C. the mixture has cured and is colorless.

### Example 14: Crosslinking of MSE 100 with Cp(SiMe₃)₃Ge⁺B(SiCl₃)₄⁻ and Acetone

2565 mg of MSE 100 and 130 mg of acetone (formula (III), 5% by weight based on MSE 100) are mixed in a SpeedMixer. 0.27 mg of Cp(SiMe₃)₃Ge⁺B(SiCl₃)₄⁻ (formula (IV), 0.011% by weight based on MSE 100), without added solvent, is then added to this mixture and the latter is mixed again for approx. 2 min in the SpeedMixer. After 5 h at 23° C. the mixture has cured and is colorless.

### Example 15: Crosslinking of MSE 100 with Cp(SiMe₃)₃Ge⁺B(SiCl₃)₄⁻ and Methyl Ethyl Ketone

2531 mg of MSE 100 and 125 mg of methyl ethyl ketone (formula (III), 5% by weight based on MSE 100) are mixed in a SpeedMixer. 1.1 mg of Cp(SiMe₃)₃Ge⁺B(SiCl₃)₄⁻ (formula (IV), 0.043% by weight based on MSE 100) dissolved in 190111 of dichloromethane is then added to this mixture and the latter is mixed again for approx. 2 min in the SpeedMixer. After 5 h at 23° C. the mixture has cured and is colorless.

### Example 16: Crosslinking of MSE 100 with Cp(SiMe₃)₃Ge⁺B(SiCl₃)₄⁻ and Methyl Ethyl Ketone

2560 mg of MSE 100 and 126 mg of methyl ethyl ketone (formula (III), 5% by weight based on MSE 100) are mixed in a SpeedMixer. 0.29 mg of Cp(SiMe₃)₃Ge⁺B(SiCl₃)₄⁻ (formula (IV), 0.011% by weight based on MSE 100), without added solvent, is then added to this mixture and the latter is mixed again for approx. 2 min in the SpeedMixer. After 5 h at 23° C. the mixture has cured and is colorless.

### Example 17: Crosslinking of MSE 100 with Cp(SiMe₃)₃Ge⁺B(C₆F₅)₄⁻ and Methyl Ethyl Ketone

2602 mg of MSE 100 and 129 mg of methyl ethyl ketone (formula (III), 5% by weight based on MSE 100) are mixed in a SpeedMixer. 1.4 mg of Cp(SiMe₃)₃Ge⁺B(C₆F₅)₄⁻ (formula (IV), 0.054% by weight based on MSE 100), without added solvent, is then added to this mixture and the latter is mixed again for approx. 2 min in the SpeedMixer. After approx. 4 h at 23° C. the mixture has cured and is colorless.

### Example 18: Crosslinking of MSE 100 with Cp(SiMe₃)₃Ge⁺B(SiCl₃)₄⁻ and Acetaldehyde Diethyl Acetal

2529 mg of MSE 100 and 134 mg of acetaldehyde diethyl acetal (5% by weight based on MSE 100) are mixed in a SpeedMixer. 1.1 mg of Cp(SiMe₃)₃Ge⁺B(SiCl₃)₄⁻ (formula (IV), 0.043% by weight based on MSE 100), without added solvent, is then added to this mixture and the latter is mixed again for approx. 2 min in the SpeedMixer. After approx. 4 h at 23° C. the mixture has cured and is colorless.

### Example 19: Crosslinking of MSE 100 with Cp*Ge⁺B(C₆F₅)₄⁻ and Paraldehyde

2536 mg of MSE 100 and 129 mg of paraldehyde (5% by weight based on MSE 100) are mixed in a SpeedMixer. 1.2 mg of Cp(SiMe₃)₃Ge⁺B(C₆F₅)₄⁻ (formula (IV), 0.047% by weight based on MSE 100), without added solvent, is then added to this mixture and the latter is mixed for approx. 2 min in the SpeedMixer. The mixture has cured after approx. 4 h at 23° C.

### Example 20: Crosslinking of MSE 100 with Cp*Ge⁺B(C₆F₅)₄⁻ and Paraldehyde

The experiment in Example 19 is repeated. After the mixing, the sample is heated to 50° C. and has cured after approx. 1 h at this temperature.

### Example 21: Crosslinking of MSE 100 with Cp*Ge⁺B(C₆F₅)₄⁻ and Dimethyl Carbonate (DMC)

2563 mg of MSE 100 and 130 mg of DMC (formula (III), 5% by weight based on MSE 100) are mixed in a SpeedMixer. 0.5 mg of Cp*Ge⁺B(C₆F₅)₄⁻ (formula (IV), 0.02% by weight based on MSE 100), without added solvent, is then added to this mixture and the latter is mixed for approx. 2 min in the SpeedMixer. The mixture has cured after approx. 7 h at 23° C.

### Example 22: Crosslinking of Silres IC 368 with Cp*Ge⁺B(C₆F₅)₄⁻ and Acetaldehyde

2533 mg of Silres IC 368 and 242 mg of acetaldehyde (formula (III), 10% by weight based on Silres IC 368) are mixed in a SpeedMixer. 1.2 mg of Cp(SiMe₃)₃Ge⁺B(C₆F₅)₄⁻ (formula (IV), 0.05% by weight based on Silres IC 368) in 200 μl of dichloromethane is then added to this mixture and the latter is mixed for approx. 2 min in the SpeedMixer. The mixture has cured after approx. 24 h at 23° C. Silres IC 368 is a hydrolytic condensate of PhSi(OMe)₃ and MeSi(OMe)₃ in the ratio 62:38 that comprises 14% by weight of methoxy groups.

### Example 23: Crosslinking of Silres IC 368 with Cp*Ge⁺B(C₆F₅)₄⁻ and Paraldehyde

2528 mg of Silres IC 368 and 131 mg of paraldehyde (5% by weight based on Silres IC 368) are mixed in a SpeedMixer. 1.2 mg of Cp(SiMe₃)₃Ge⁺B(C₆F₅)₄⁻ (formula (IV), 0.047% by weight based on Silres IC 368) in 200 μl of dichloromethane is then added to this mixture and the latter is mixed for approx. 2 min in the SpeedMixer. The mixture has cured after approx. 24 h at 23° C.

### Example 24: Crosslinking of TRASIL with Cp*Ge⁺B(C₆F₅)₄⁻ and Methyl Ethyl Ketone

Example 23 is repeated using TRASIL instead of Silres IC 368. The mixture has cured after approx. 24 h at 23° C. TRASIL is a hydrolytic condensate of MeSi(OEt)₃ with a molar ratio of EtO:Me=0.7:1.

1-15. (canceled)

16. A process for preparing siloxanes, comprising:
providing at least one alkoxy-organosilicon compound which is selected from compounds of the general formula (I)
R¹R²R³Si—OR^{x} (I),
wherein R¹, R² and R³ are independently selected from the group comprising halogen, unsubstituted or substituted C₁-C₂₀ hydrocarbon radical and unsubstituted or substituted C₁-C₂₀ hydrocarbonoxy radical, and
wherein two of the radicals R¹, R² and R³ may together form a monocyclic or polycyclic, unsubstituted or substituted C₂-C₂₀ hydrocarbon radical, where substituted in each case means that the hydrocarbon radical or hydrocarbonoxy radical independently has at least one of the following replacements:
wherein replacement of a hydrogen atom is done by halogen,
—CH(═O), —C≡N, —OR^{z}, —SR^{z}, —NR^{z}₂, and —PR^{z}₂,
wherein replacement of a CH₂ group is done by —O—, —S— or —NR^{z}—,
wherein replacement of a CH₂ group not bonded directly to Si is done by —C(═O)—,
wherein replacement of a CH₃ group is done by —CH(═O), and
wherein replacement of a C atom is done by an Si atom,
wherein R^{z} is in each case independently selected from the group comprising C₁-C₆ alkyl radical and C₆-C₁₄ aryl radical,
where R^{x} is a C₁-C₂₀ hydrocarbon radical, and/or
wherein the at least one alkoxy-organosilicon compound is selected from compounds of the general formula (II)
(SiO_{4/2})ₐ(R^{y}SiO_{3/2})_{b}[(R^{x}O)SiO_{3/2}]_{b′}(R^{y}₂SiO_{2/2})_{c}[(R^{x}O)R^{y}SiO_{2/2}]_{c′}[(R^{x}O)₂SiO_{2/2}]_{c″}(R^{y}₃SiO_{1/2})_{d}[(R^{x}O)R^{y}₂SiO_{1/2}]_{d′}[(R^{x}O)₂R^{y}SiO_{1/2}]_{d″}[(R^{x}O)₃SiO_{1/2}]_{d′″} (II),
wherein R^{y} is as defined for R¹, R² or R³, and
wherein the indices a, b, b′, c, c′, c″, d, d′, d″, d′″ indicate the number of the respective siloxane unit and independently represent an integer from 0 to 100 000, with the proviso that the sum total of all indices has a value of at least 2 and at least one of the indices b′, c′, c″, d′, d″ or d′″ is not equal to 0; and
reacting the at least one alkoxy-organosilicon compound in the presence of at least one cationic silicon and/or germanium compound at a temperature of −40° C. to 250° C.

17. The process of claim 16, wherein the reaction takes place at a temperature of 0° C. to 200° C., preferably 10° C. to 100° C.

18. The process of claim 16, wherein R¹, R² and R³ are independently selected from the group comprising unsubstituted or substituted C₁-C₁₂ hydrocarbon radical and unsubstituted or substituted C₁-C₁₂ hydrocarbonoxy radical.

19. The process of claim 16, wherein R¹, R² and R³ are independently selected from the group comprising methyl, ethyl, vinyl, phenyl, methoxy and ethoxy.

20. The process of claim 16, wherein R^{x} is independently selected from the group comprising unsubstituted or substituted C₁-C₁₂ hydrocarbon radical, vinyl and phenyl.

21. The process of claim 16, wherein the indices a, b, b′, c, c′, c″, d, d′, d″, d′″ are independently selected from an integer in the range of 0 to 1000.

22. The process of claim 16, wherein the reaction is performed in the presence of at least one carbonyl compound.

23. The process of claim 22, wherein the carbonyl compound is selected from compounds of the general formula (III)
R^{d}—(X)ₙ—CO—(X)ₙ—R^{d} (III),
wherein R^{d} is independently hydrogen or an unsubstituted or substituted C₁-C₄₀ hydrocarbon radical,
wherein the two radicals R^{d} may be joined to one another and form a ring,
wherein X is independently oxygen, —N(H)— or —N(R^{d})—, and
wherein independently n=0 or 1.

24. The process of claim 23, wherein n=0 and R^{d} is independently hydrogen or a C₁-C₁₂ hydrocarbon radical.

25. The process of claim 22, wherein the carbonyl compound is used in a proportion by weight of 0.01% to 500%, preferably 0.1% to 100%, particularly preferably 1% to 50%, based on the compound of the general formula (I) or (II).

26. The process of claim 16, wherein the cationic silicon and/or germanium compound is selected from the group comprising cationic silicon(II), silicon(IV), germanium(II) and germanium(IV) compounds.

27. The process of claim 16, wherein the cationic silicon and/or germanium compound is selected from compounds of the general formula (IV)
([M(II)Cp]⁺)ₐX^{a-} (IV),
wherein X^{a-} is an a-valent anion, where a=1, 2 or 3,
wherein M is Ge(II) or Si(II),
wherein Cp is π-bonded cyclopentadienyl radical of the general formula (IVa) 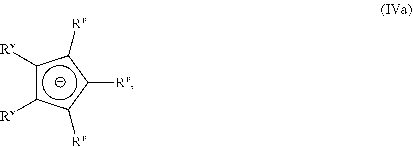
wherein R^{v} is independently selected from the group of hydrogen, unsubstituted or substituted C₁-C₂₀ hydrocarbon radical, unsubstituted or substituted C₁-C₂₀ hydrocarbonoxy radical and triorganosilyl radical of the formula —SiR^{b}₃,
wherein R^{b} is independently selected from the group of C₁-C₂₀ hydrocarbon radical and C₁-C₂₀ hydrocarbonoxy radical,
wherein two radicals R^{v} may also be joined to one another so that bi- or polycyclic rings are formed; and/or
wherein the cationic silicon and/or germanium compound is selected from compounds of the general formula (V) 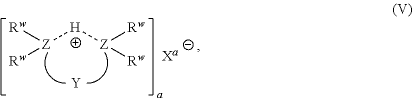
wherein X^{a-} is an a-valent anion, where a=1, 2 or 3,
wherein Z is independently silicon(IV) or germanium(IV), and
wherein Y is a divalent C₂-C₅₀ hydrocarbon radical and where R^{w} is independently hydrogen or a C₁-C₅₀ hydrocarbon radical.

28. The process of claim 27, wherein a=1 in formulae (IV) and/or (V).

29. The process as claimed in claim 28, wherein X⁻ is independently selected from the group comprising [B(SiCl₃)₄]⁻, compounds of the formula [B(R^{a})₄]⁻ and compounds of the formula [Al(OR^{c})₄]⁻, and wherein R^{c} is independently a fluorinated, aliphatic C₃-C₁₂ hydrocarbon radical.

30. The process of claim 27, wherein the cationic silicon and/or germanium compound is selected from the group comprising silicon(II) and germanium(II) compounds of formula (IV),
wherein R^{v} is independently selected from the group comprising methyl radical, hydrogen and trimethylsilyl radical, and
wherein X^{a-}, where a=1, is selected from the group comprising [B(SiCl₃)₄]⁻, [B(C₆F₅)₄]⁻, {B[C₆F₄(4-TBS)]₄}⁻, where TBS=SiMe₂tert-butyl, and [B(2-Naph^{F})₄]⁻, where 2-Naph^{F}=perfluorinated 2-naphthyl radical.

31. The process of claim 26, wherein the cationic silicon and/or germanium compound is selected from the group comprising silicon(IV) and germanium(IV) compounds of the general formula (V),
where R^{w} is independently selected from the group comprising C₁-C₆ alkyl radical and phenyl radical,
where Y is a 1,8-naphthalenediyl radical, and
where X⁻ is selected from the group comprising [B(C₆F₅)₄]⁻ and [B(SiCl₃)₄]⁻.
